(19) United States
(12) Patent Application Publication
(10) Pub. No.: US 2025/0377035 A1
(43) Pub. Date: Dec. 11, 2025

(54) DISPLACEMENT ASSEMBLY

(71) Applicant: Dr. Mach GmbH & Co. KG, München (DE)

(72) Inventors: Michael Jonischkeit, Rosenheim (DE); Peter Kohrs, Meine (DE)

(73) Assignee: Dr. Mach GmbH & Co. KG, München (DE)

(21) Appl. No.: 18/876,988

(22) PCT Filed: Jun. 27, 2023
(86) PCT No.: PCT/EP2023/067410

§ 371 Date: Dec. 19, 2024

(30) Foreign Application Priority Data
Jun. 29, 2022 (DE) 10 2022 116 159.5

(51) Int. Cl. F16H 1/20; F16H 1/24; F16H 37/06

(52) U.S. Cl. CPC F16H 1/203; F16H 1/24; F16H 37/065

(57) ABSTRACT

Disclosed is a displacement assembly, comprising
a displacement unit (which is connected to a suspension unit and is displaceable relative to the suspension unit,
wherein two gear wheels are connected to the suspension unit in a manner fixed in position, the axes of rotation of which gear wheels are arranged at an angle relative to one another, wherein the two gear wheels are designed to mesh with a tooth surface, which is connected to the displacement unit, in such a way that, on account of activation of the gear wheels, the displacement unit is displaced relative to the suspension unit, wherein the tooth surface is designed in such a way, and the teeth of the gear wheelsare designed for such a purpose that, upon activation of just one of the two gear wheels, teeth of the other gear wheel, respectively, move through between teeth of the tooth surface. The invention further relates to a system comprising a displacement assembly of this kind.

The invention relates to a displacement assembly, comprising a displacement unit which is connected to a suspension unit and is displaceable relative to the suspension unit. The invention further relates to a system which comprises a displacement assembly of this kind and at least one component to be pivoted, which is arranged on the displacement unit of the displacement assembly.

From the prior art, such systems are known for example in the form of lighting units, which comprise displacement assemblies of the type mentioned at the outset and are used for example in the field of medical technology, and there in particular in the field of operation technology. In this case, the illumination of the surgical wound constitutes a specific application. However, it should already be noted at this point that, although the invention will be explained in the following in part with reference to the example of illumination of surgical wounds, no restriction of any kind can be derived herefrom.

In order to achieve ideal illumination of a surgical wound, also known as “situs”, the operator must generally orient the light according to the prior art by hand during the operation. This requires complex mechanics for the lights, and in addition the operator has to keep interrupting his work for each readjustment of the light. This can extend the operation time and thus constitute additional stress for the patient.

Although in the past lighting units have already been proposed comprising displacement assemblies which can be actuated by a motor, it has been found that the mechanics used in this connection usually cannot fulfil the requirements made with respect to optimum adjustability together with a high level of reliability, small installation space requirement, and acceptable manufacturing costs.

The object of the present invention is therefore that of providing a displacement assembly and a lighting unit comprising a displacement assembly of this kind, which can provide a solution here.

According to a first aspect of the invention, this object is achieved by a displacement assembly comprising a displacement unit which is connected to a suspension unit and is displaceable relative to the suspension unit, two gear wheels being connected to the suspension unit in a manner fixed in position, the axes of rotation of which gear wheels are arranged at an angle relative to one another, the two gear wheels being designed to mesh with a tooth surface, which is connected to the displacement unit, in such a way that, on account of activation of the gear wheels, the displacement unit is displaced relative to the suspension unit, the tooth surface being designed in such a way, and the teeth of the gear wheels being designed for such a purpose that, upon activation of just one of the two gear wheels, teeth of the other gear wheel, respectively, move through between teeth of the tooth surface.

According to the invention, the displacement of the displacement unit can take place in at least two directions, in particular orthogonal to one another, only by the interaction of the two gear wheels with a single tooth surface. The two gear wheels forming a drive thus interact with a tooth surface forming the common output. As a result of this, a particularly compact displacement assembly, which can nonetheless be used in a versatile manner, can be provided.

Preferably, the axis of rotation of the non-activated gear wheel, the teeth of which move through between the teeth of the tooth surface, extends in this case substantially in parallel with a displacement direction of the displacement of the displacement unit brought about by activation of a gear wheel. In particular, the teeth of the other gear wheel, respectively, can move through between the teeth of the tooth surface in a substantially sliding manner, i.e. substantially without a rolling movement.

Likewise, simultaneous activation of both gear wheels can bring about a displacement of the displacement unit, which corresponds to a superimposition of the displacements caused in each case by activation of just one of the two gear wheels. As a consequence of this, according to the invention a displacement assembly that can be adjusted in a particularly versatile manner can furthermore be achieved, which allows for always optimal illumination, in particular in the case of complex operative procedures. In this case, activation of the gear wheels can correspond in each case to clockwise or anti-clockwise rotation.

Preferably, the axes of rotation of the gear wheels may extend in a common plane and/or may be arranged at an angle of 60° to 120°, preferably of 80° to 100°, relative to one another, particularly preferably may be arranged substantially orthogonally to one another.

In order to be able to achieve a toothing of the tooth surface that is sufficiently reliable, i.e. wear-resistant, and can nonetheless be produced with acceptable effort, according to one embodiment of the invention it is proposed that the teeth of the gear wheels and/or the teeth of the tooth surface are designed so as to be substantially cone-shaped and/or involute-shaped and/or round and/or as a rack and pinion gearing. The teeth of the tooth surface and/or of the gear wheels also do not necessarily have to be designed identically to one another, but rather each tooth or a predetermined number of teeth can in each case be designed differently from one another.

In this connection, it should be noted that each tooth of the tooth surface should be designed in such a way that it can mesh with the teeth of the gear wheels having an orthogonal pivot axis, in order to bring about the corresponding displacement of the displacement unit. The teeth of the tooth surface can thus for example comprise four tooth flanks, consisting of two pairs of two mutually opposing tooth flanks in each case, mutually opposing tooth flanks in each case being designed to mesh with one of the two gear wheels in the suspension unit. Furthermore, the teeth of the tooth surface can also be designed so as to be rotationally symmetrical, for example conical or frustoconical. This is found to be advantageous in particular in the case of a rotatory displacement.

In principle, the displacement unit can be connected to the suspension unit in such a way that the displacement unit can be displaced in a translational manner relative to the suspension unit. If the displacement unit according to the invention is used for example in connection with an illumination unit, it may, however, be advantageous if an angle of arrangement of the displacement unit relative to the suspension unit, and thus a light-emission angle of the illumination unit, can be adjusted. Advantageously, the displacement unit can therefore be connected to the suspension unit via a hinged bearing system and be pivotable relative to the suspension unit, it being possible for the hinged bearing system to comprise at least one pivot axis. As a result, the activation of the two gear wheels can bring about a pivoting movement of the displacement unit relative to the suspension unit, about the at least one pivot axis.

In a development of this embodiment, the tooth surface can have a curvature, it being possible for the central axis of the curvature to coincide with the at least one pivot axis. This makes it possible for the two gear wheels to be able to continuously mesh with, i.e. come into engagement with, the tooth surface, irrespective of the pivot angle present in each case.

If the displacement unit is connected to the suspension assembly, via the hinged bearing system, so as to be pivotable about more than one pivot axis, then, in an analogous manner, the tooth surface can have a curvature per pivot axis, it being possible in each case for a central axis of a curvature to coincide with an associated pivot axis.

Advantageously, the axes of rotation of the two gear wheels are not only angled relative to one another, but rather also extend in such a way that they are askew relative to one another. In the case of askew axes of rotation, the two gear wheels can consequently have diameters different from one another. Alternatively, it is conceivable that the axes of rotation of the two gear wheels intersect, which leads to a particularly compact design of the displacement assembly according to the invention.

In order to moreover be able to ensure that the meshing of the two gear wheels can take place with as small a sliding portion as possible, and thus low wear, it is preferable that at least one of the axes of rotation of the two gear wheels can extend substantially in parallel with the at least one pivot axis. In this connection, “substantially in parallel” means in particular that an angle formed between at least one of the axes of rotation and the at least one pivot axis is at most ±10°, preferably at most ±5°, but particularly preferably 0°.

Furthermore, it is conceivable in principle to design the toothing of the gear wheels or the tooth surface as helical teeth or a worm gearing. This consequently allows for an angled arrangement between the axis of rotation of a respective gear wheel and the at least one pivot axis of the hinged bearing system.

In order to be able to set a virtually unlimited number of displacement positions of the displacement unit relative to the suspension assembly, according to a further embodiment it is proposed that the hinged bearing system may be a gimbal bearing system having two pivot axes, in which the two pivot axes are arranged orthogonally to one another. A gimbal bearing system may also prove particularly advantageous in connection with an illumination unit as mentioned above, since said bearing system does not only allow a corresponding plurality of light-emission angles, but rather can also be used in connection with, for example, recessed ceiling lights.

If the tooth surface has the above-mentioned curvature, the tooth surface can advantageously be designed so as to be spherical at least in part, i.e. to reproduce a sphere surface portion, at least in part.

In addition or alternatively, a centre of curvature of the tooth surface can coincide with an intersection point between two pivot axes of the hinged bearing system.

For activation, i.e. preferably for rotatory driving, of the two gear wheels, each gear wheel can be associated with a separate drive unit which is designed to bring about the activation of the respective gear wheel. In this connection, a signal input of the respective drive unit can be connected to a corresponding signal output of a control unit. The control unit can, but does not have to, be a component of the displacement assembly according to the invention, and can preferably be designed in such a way that it actuates the two drive units, and thus the two gear wheels, in such a way that in each case a desired displacement of the displacement unit relative to the suspension unit results.

It should be added that, in order to achieve a low-friction tooth engagement between the gear wheels and tooth surface, the tooth flanks of the teeth of the gear wheels and/or the tooth flanks of the teeth of the tooth surface can be chamfered at the side and/or can have a friction-reducing coating and/or can be designed so as to be rotationally symmetrical, for example conical or frustoconical.

According to a further aspect of the invention, the above-mentioned object is achieved by a system which comprises a displacement assembly according to the invention and at least one component to be pivoted, which is arranged on the displacement unit of the displacement assembly. Several advantages result from this, for example easier cable routing, since cables that may be required for the component are not moved, and therefore there is no risk of a cable break, and a higher displacement speed, since the mass moved is smaller. Furthermore, the motors of the gear wheels can be designed identically, since no motor has to also move the other, respectively. This furthermore results in a smaller installation space requirement.

The component to be pivoted can for example comprise a light and/or a camera and/or a laser pointer and/or a mirrored tile or the like. If the component to be pivoted is, for example, the light, the system can be designed such that a displacement of the displacement unit relative to the suspension unit brings about a change in the surface illuminated by the light.

Thus, an emission angle of the light can be adjusted by the installation space-saving displacement assembly according to the invention. For this purpose, the control signal can be transmitted to the displacement assembly for example from an input unit operated by a user, e.g. an operator, and/or from a control unit on the basis of a detected parameter, in particular an illumination intensity of a predetermined region, and/or an item of sensor information, for example from a depth camera.

If, for example, a plurality of systems according to the invention comprising a light or the like is attached to a ceiling of an operating theatre or the like, consequently a significantly improved illumination of the surgical wound can be achieved.

With respect to the further advantages and effects of the system according to the invention, reference is made to the above discussion of the displacement assembly according to the invention.

The invention will be described in greater detail in the following on the basis of the accompanying drawings, with reference to an embodiment. In the drawings:

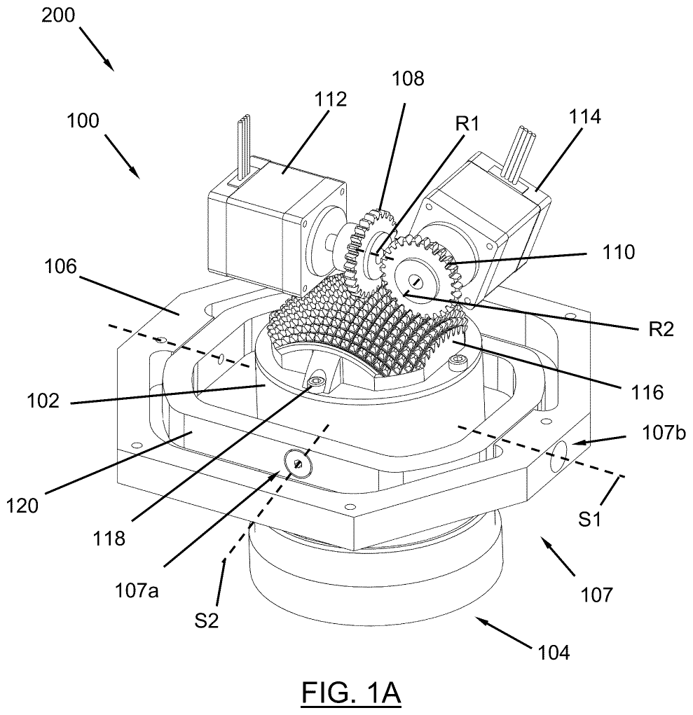

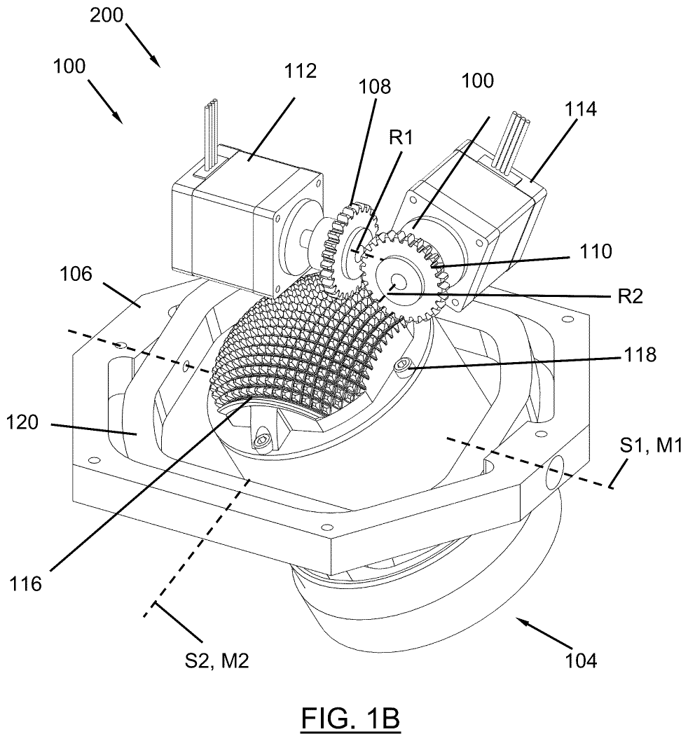

FIG. 1A is a perspective view of a displacement assembly according to the invention, according to an embodiment,

FIG. 1B: shows the displacement assembly according to FIG. 1A in a state pivoted proceeding from FIG. 1A,

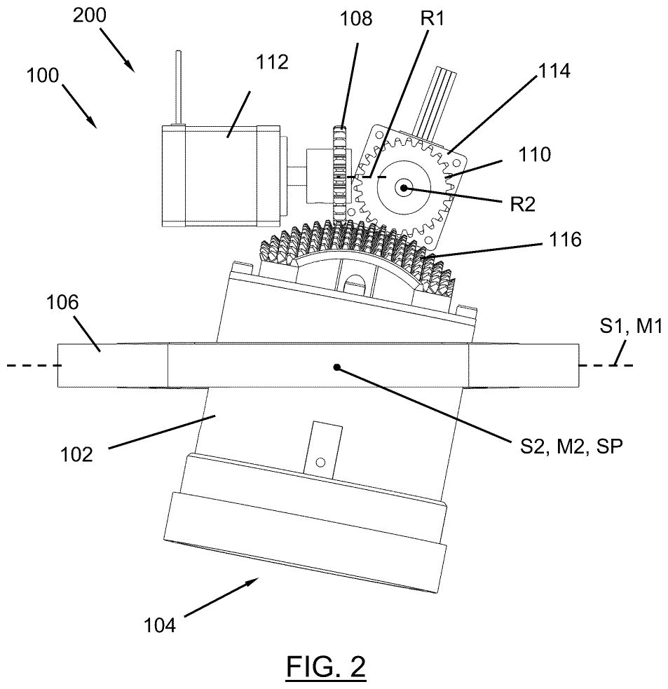

FIG. 2 is a side view of the displacement assembly from FIG. 1B in the pivoted state,

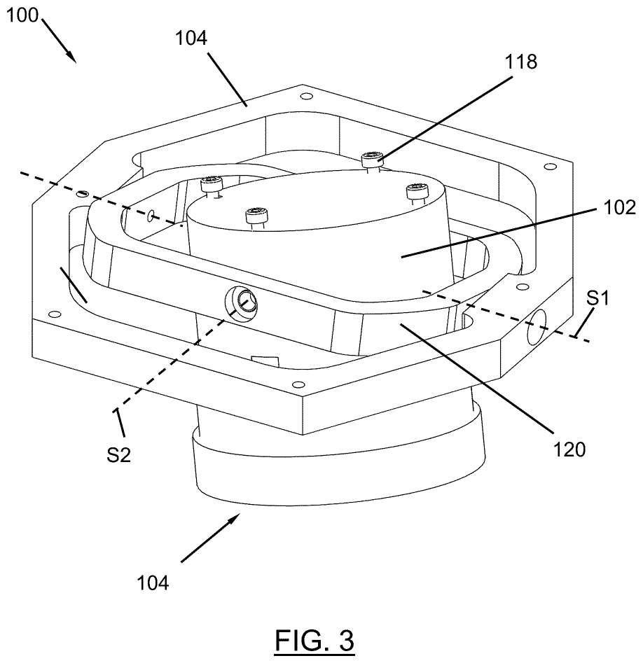

FIG. 3 is a perspective partial view of the displacement assembly according to the invention, in which the tooth surface and the gear wheels are removed,

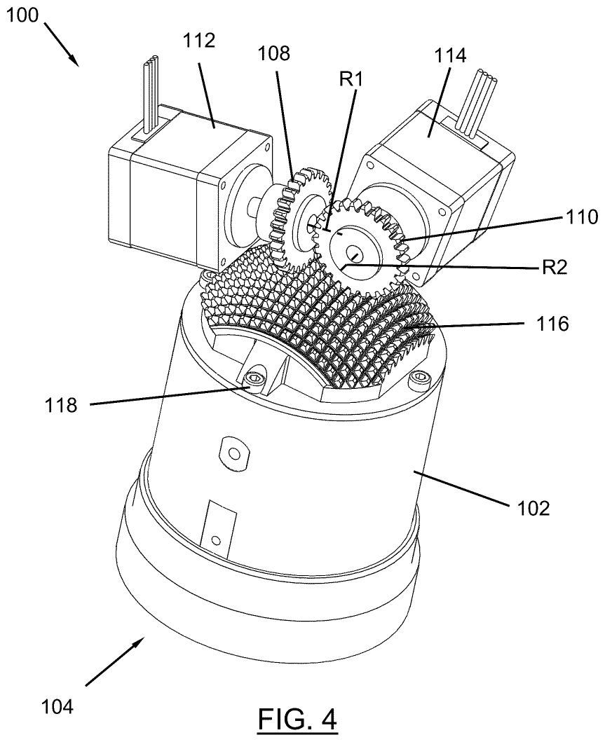

FIG. 4 is a perspective partial view of the displacement assembly from FIG. 1B, in which the suspension unit is removed, and

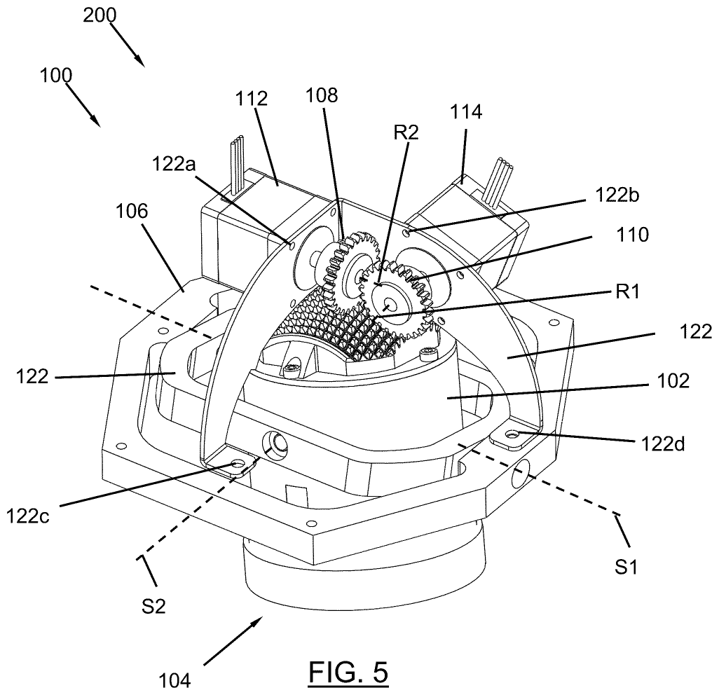

FIG. 5 is a perspective view of the displacement assembly from FIG. 1A, which is supplemented by a motor retaining element for fastening motors of gear wheels.

In FIG. 1, a displacement assembly according to the invention is denoted generally by reference sign 100. The displacement assembly 100 comprises a displacement unit 102 which is connected to a suspension unit 106 and is displaceable relative to said suspension unit. Two gear wheels 108 and 110 are connected to the suspension unit 106 in a manner fixed in position. The gear wheels 108 and 110 are rotatable about axes of rotation R1 and R2, respectively. For this purpose, the gear wheel 108 is assigned a motor 112, while the gear wheel 110 is assigned a corresponding motor 114. The motors 112 and 114 can be designed as electric motors and can be electrically connected to an electrical energy source (not shown in the drawings).

The two gear wheels 108 and 110 mesh with a tooth surface 116, which is connected to the displacement unit 102. In the embodiment shown, in this case the tooth surface 116 is screwed to the displacement unit 102 by fastening means in the form of screws 118.

The two gear wheels 108 and 110 mesh with the tooth surface 116 in such a way that, on account of activation of the gear wheels 108 and/or 110, i.e. a rotation of the gear wheels about the axes of rotation R1 and R2, respectively, the displacement unit 102 is displaced relative to the suspension unit 106. In the embodiment shown, the displacement of the displacement unit 102 can in this case consist of pivoting about a pivot axis S1 and/or pivoting about a pivot axis S2. For this purpose, the displacement unit 102 is hingedly connected to an intermediate suspension unit 120 via a bearing 107a of a hinged bearing system 107, as a result of which the pivotability about the pivot axis S2 is made possible. The intermediate suspension unit 120 is in turn hingedly connected to the suspension unit 106 via a bearing 107b of the hinged bearing system 107, such that pivoting of the intermediate suspension unit 120 and thus of the displacement unit 102, about the pivot axis S1 relative to the suspension unit 106 is made possible. The suspension unit 106 and the intermediate suspension unit 120 consequently form the hinged bearing system 107 in the form of a gimballed suspension having the two intersecting pivot axes S1 and S2.

The tooth surface 116 can be designed in such a way that a centre of curvature M1 and/or M2 of a curvature of the tooth surface 116 coincides with the pivot axis S1 and/or S2 (see FIG. 2). The teeth of the tooth surface 116 and the corresponding teeth of the gear wheels 108 and 110 are furthermore configured in such a way that, upon activation of just one of the two gear wheels 108, 110, the teeth of the other gear wheel, respectively, move through between teeth of the tooth surface 116. Thus, if just one of the two gear wheels 108 and 110 rotates, the teeth of the non-rotating gear wheel do not perform a movement about the respective axis of rotation R1 and R2, respectively, but rather simply a sliding movement relative to the teeth of the tooth surface 116, which is brought about by the rotation of the other gear wheel, respectively. Nonetheless, it is of course also conceivable to activate both the gear wheel 108 and the gear wheel 110 simultaneously, i.e. to have these rotate about the axes R1 and R2, respectively, such that the displacement unit 102 is displaced or pivoted both about the pivot axis S1 and about the pivot axis S2. In this case, a drive movement of the respective gear wheel, meshing with the tooth surface, can take place in a manner superimposed by the above-described sliding movement.

FIG. 1A shows the displacement assembly 100 in an upright state, i.e. in a state in which the displacement unit 102 is not pivoted either about the pivot axis S1 or about the pivot axis S2. In contrast, FIG. 1B shows the displacement assembly 100 from FIG. 1A after this has been pivoted about the pivot axis S1 or S2, respectively, on account of a rotation of the gear wheels 108 and 110 about the axes of rotation R1 and R2, respectively. As already mentioned above, the displacement unit 102 can, however, also be displaced simply about the pivot axis S1 or the pivot axis S2, proceeding from the configuration shown in FIG. 1A.

FIG. 2 is a side view of the displacement assembly 100 in the configuration shown in FIG. 1B. In the embodiment shown, the axes of rotation R1 and R2 of the gear wheels 108 and 110, respectively, are arranged orthogonally to one another. However, it should be noted that this is not essential. The axes of rotation R1 and R2 can also be angled in any manner, as required, i.e. be arranged at an angle 90° different from one another. Furthermore, in the embodiment shown, the axes of rotation R1 and R2 are arranged in such a way that they are arranged askew relative to one another (see FIG. 2). However, it is nonetheless also conceivable that the axes of rotation R1 and R2 may be arranged in such a way that they intersect.

In an analogous manner, in the embodiment shown the pivot axes S1 and S2 are arranged orthogonally to one another.

As can be seen for example in FIGS. 1A, 1B, 2, 4 and 5, in the embodiment shown the tooth surface 116 is formed so as to be spherical, i.e. it reproduces a sphere surface portion. In this case, a centre of curvature of the tooth surface 116 can coincide with an intersection point SP of the two pivot axes S1 and S2 (see FIG. 2).

It should also be added that the teeth of the gear wheels 108 and 110 and/or the teeth of the tooth surface 116 can be designed so as to be substantially cone-shaped and/or involute-shaped and/or round and/or as a rack and pinion gearing. The teeth of the gear wheels 108 and 110 and/or the teeth of the tooth surface 116 can also be chamfered at the side and/or have a friction-reducing coating (not shown).

In FIG. 3, for improved clarity the displacement unit 102 is shown without the tooth surface 116 and the gear wheels 108 and/or 110.

FIG. 4, in contrast, shows the displacement unit 102 comprising the tooth surface 116 arranged thereon and the associated gear wheels 108 and 110, the suspension unit 106 and the intermediate suspension unit 120 being omitted.

The displacement assembly 100 shown in FIG. 5 corresponds to the displacement assembly 100 according to FIG. 1A or 1B, but is additionally supplemented by a motor retaining element in the form of a motor retaining plate 122 for the motors 112 and 114 of the gear wheels 108 and 110, respectively. The motor retaining plate 122 can be screwed to the motor 112 by a screw connection 122a (indicated only schematically), and to the motor 114 by a screw connection 122b (also indicated only schematically). In addition to a screw connection, alternatively other suitable fastening methods, for example adhesive bonding, welding, soldering and the like can be used.

By means of the motor retaining plate 122, the motors 112 and 114, and thus the gear wheels 108 and 110, can be connected to the suspension unit 106 in a manner fixed in position. This can also be achieved by means of screw connections 122c and 122d (indicated only schematically here), or the like.

A light 104 is arranged on the displacement unit 102, as a component to be pivoted. The displacement assembly 100 and the light 104 consequently form a system 200 in the form of a lighting unit 200, the lighting unit 200 being designed in such a way that a displacement of the displacement unit 102 relative to the suspension unit 106 brings about a change in the surface illuminated by the light 114. However, it should be noted that the system according to the invention is not limited to a lighting unit. Alternatively, instead of the light 114, a camera and/or a laser pointer and/or a mirror tile or the like can also be arranged on the displacement unit 102, as a component to be pivoted.

1. Displacement assembly, comprising
a displacement unit which is connected to a suspension unit and is displaceable relative to the suspension unit,
wherein two gear wheels are connected to the suspension unit in a manner fixed in position, wherein axes of rotation of which gear wheels are arranged at an angle relative to one another,
wherein the two gear wheels are designed to mesh with a tooth surface, which is connected to the displacement unit, in such a way that, on account of activation of the gear wheels, the displacement unit is displaced relative to the suspension unit,
wherein the tooth surface is designed in such a way, and teeth of the gear wheels are designed for such a purpose that, upon activation of just one of the two gear wheels, teeth of the other gear wheel, respectively, move through between teeth of the tooth surface.

2. Displacement assembly according to claim 1,
wherein the axes of rotation of the gear wheels extend in a common plane and/or are arranged at an angle of 60° to 120° relative to one another.

3. Displacement assembly according to claim 1,
wherein the displacement unit is connected to the suspension unit (106) via a hinged bearing system and is pivotable relative to the suspension unit, the hinged bearing system comprising at least one pivot axis.

4. Displacement assembly according to claim 3,
wherein the tooth surface has a curvature, a central axis of the curvature coinciding with the at least one pivot axis.

5. Displacement assembly according to claim 4,
wherein the tooth surface has a curvature per pivot axis, in each case a central axis of a curvature coinciding with an associated pivot axis.

6. Displacement assembly according to claim 1,
wherein the axes of rotation of the two gear wheels intersect or are askew relative to one another.

7. Displacement assembly according to claim 3,
wherein at least one of the axes of rotation of the two gear wheels extends substantially in parallel with the at least one pivot axis.

8. Displacement assembly according to claim 3,
wherein the hinged bearing system is a gimbal bearing system having two pivot axes, in which the two pivot axes are arranged orthogonally to one another.

9. Displacement assembly according to claim 1,
wherein the tooth surface is designed so as to be spherical at least in part, i.e. reproduces a sphere surface portion, at least in part.

10. Displacement assembly according to claim 3,
characterised in that wherein a centre of curvature of the tooth surface coincides with an intersection point between two pivot axes of the hinged bearing system.

11. Displacement assembly according to claim 1,
characterised in that wherein each gear wheel is associated with a separate drive unit (112, 114) which is designed to bring about the activation of the respective gear wheel (108, 110).

12. Displacement assembly according to claim 1,
characterised in that wherein the teeth of the gear wheels or the teeth of the tooth surface-are designed so as to be substantially cone-shaped and/or involute-shaped and/or round and/or as a rack and pinion gearing.

13. Displacement assembly according to claim 1,
characterised in that thewherein tooth flanks of the teeth of the gear wheels and/or tooth flanks of the teeth of the tooth surface are chamfered at the side and/or have a friction-reducing coating.

14. System which comprises a displacement assembly according to claim 1 and at least one component to be pivoted, which is arranged on the displacement unit of the displacement assembly.
